(19) United States
(12) Patent Application Publication
(10) Pub. No.: US 2013/0013597 A1
(43) Pub. Date: Jan. 10, 2013

(54) Processing Repetitive Data

(75) Inventors: Yixin He, Hangzhou (CN); Ruihai Ye, Hangzhou (CN); Xieyao Wu, Hangzhou (CN); Wenbo Zhang, Hangzhou (CN)

(73) Assignee: ALIBABA GROUP HOLDING LIMITED, Grand Cayman (KY)

(21) Appl. No.: 13/522,579

(22) PCT Filed: Jun. 14, 2012
(86) PCT No.: PCT/US12/42498

§ 371 Date: Jul. 17, 2012

(30) Foreign Application Priority Data
Jun. 17, 2011 (CN) 201110164850.1

(51) Int. Cl. G06F 17/30

(52) U.S. Cl. 707/736; 707/758; 707/E17.005

(57) ABSTRACT

The present disclosure introduces a method, an apparatus, and a system of processing repetitive data. In an example embodiment, the data structure of the comparison data to be compared is processed as having a same data structure of the data in the repetition database. The repetition database is formed by an internal memory mapping after processing data in a database according to a preset data structure. The processed comparison data is compared with data in the repetition database to determine whether the comparison data is repetitive data. After it is determined that the comparison data is not repetitive data, the comparison data is written into the database. The techniques described herein improve the efficiency of the servers for eliminating repetitive data and save the server resources.

### CROSS REFERENCE TO RELATED PATENT APPLICATIONS

This application is a national stage application of an international patent application PCT/US12/42498, filed Jun. 14, 2012, which claims foreign priority to Chinese Patent Application No. 201110164850.1 filed on Jun. 17, 2011, entitled “Method, Apparatus and System of Processing Repetitive Data,” which applications are hereby incorporated by reference in their entirety.

### TECHNICAL FIELD

The present disclosure relates to the field of network technology and, more specifically, to a method, an apparatus, and a system of processing data repetition.

### BACKGROUND

In terms of websites, data repetition is unavoidable. For example, repetitive product information appears in e-commerce sites. The current technology generally uses three steps to eliminate data repetition. (For the convenience of description, information that requires determining whether it is repetitive data is regarded as A, and the information to be extracted from a storage system to be compared with A is regarded as B).

A system performs data extraction logic. This step is used to extract the data required for comparison from the data storage system. In terms of massive data, the size of the data set directly determines the operational efficiency of the entire system. In this step, the linear queuing method is generally used. In other words, the first piece of information is processed before the next piece of information is processed. The following methods are used to filter B.

At a first method, each information in B is compared with A by querying a database or other data source. The first method does not filer B.

At a second method, only information in B that has apparent commonality with A (e.g., information sent from a same publisher or the information in B that belongs to the same industry as A) is filtered for comparison based on one or more preset conditions to limit the query conditions.

The following example of eliminating repetitive product information (other repetitive information may be eliminated in the same manner) is used to illustrate the above second method. FIG. 1 illustrates a flowchart of an example method of data extraction to eliminate repetitive product information under the current technology. As shown in FIG. 1, the process includes the following steps. At 102, member distribution information is read. At 104, the information is read one-by-one according to the industry. At 106, the information is extracted according to a sequence. At 108, it is determined whether the information is repetitive data. If the information is not repetitive data, operation 106 is performed. If the information is repetitive data, operation 110 is performed. At 110, the repetitive data is eliminated.

The operation 108 determines whether A is repetitive data. The operation uses an algorithm to determine whether the information is similar. Different algorithms can directly affect the accuracy and efficiency of the system's processing resolution. The current technology normally uses the following methods.

A first method performs full comparison of all data in A with B. A second method performs full comparison of selected key data in A and B. A third method compares degree of similarity and determines whether A and B are the same according to the degree of similarity between data in A and B. For example, a certain portion of descriptive text may be compared during a similarity degree comparison.

The above processing methods in the current technology are more suited for relatively smaller quantities of data. In terms of massive data, the efficiency of the above processing methods is lower. For example, the algorithm efficiency of current technology to eliminate repetitiveness is O(n), where n represents the quantity of data and O(n) represents the execution time of the algorithm. O(n) and n have a linear relationship or even an exponential relationship. Regardless of the functional relationship, the value of O(n) increases as the value of n increases. Therefore, when n is quite large, it results in an overload of the server that performs the algorithm with the complexity of O(n) and therefore the repetitive data cannot be processed in a timely manner. The information verification speed thus cannot keep up with the distribution speed of new information.

In the current technology, the above problem is resolved by reducing the data set (i.e. the n value) to reduce the server load. For example, the data may be read one-by-one according to the industry of the information publisher. Although the entire data set is compressed to a certain degree (i.e., the value n), the algorithm efficiency may be regarded as O(n(n−1)/2). When the information publisher has a lot of information (e.g., massive data), the algorithm efficiency is still low. Therefore, to resolve this issue, the current technology may have to increase hardware capacities to satisfy the requirement to remove data repetition. In some cases, reliance only on the hardware input may not reach satisfactory results. Such an approach has its problems too as it cannot meet requirements of future expansion and wastes server resources, thereby creating overall low efficiency.

### SUMMARY

The present disclosure discloses a method, an apparatus, and a system of processing data repetition.

The present disclosure provides a method of processing repetitive data. The data structure of the comparison data to be compared is processed as having a same or substantially same data structure of the data in the repetition database. The repetition database is formed by an internal memory mapping after data in a database is processed according to a preset data structure. The processed comparison data is compared with data in the repetition database to determine whether the comparison data is repetitive data. After it is determined that the comparison data is not repetitive data, the comparison data is written into the database.

The processed comparison data includes first information for complete matching and second information for similarity degree matching. It is determined whether the comparison data is repetitive data as follows. When the first information of the comparison data is the same as or substantially similar to the first information of the data in the repetition database and a similarity degree between the second information of the comparison data and the second information of the data in the repetition data is higher than a threshold, the comparison data is determined to be repetitive data.

When the processed comparison data also contains one or more images, it is determined whether the comparison data is repetitive data as follows. When the first information of the comparison data is the same or substantially the same as the first information of the data in the repetition database and a similarity degree between the second information of the comparison data and the second information of the data in the repetition data is higher than a threshold, a form of relationship between the comparison data and the repetitive data is determined based on a relationship between sizes of the one or more images in the comparison data and sizes of the one or more images in the data in the repetition database. The form of relationship between the comparison data and the repetitive data may include one of the following: the comparison data is same as the data in the repetition database, the comparison data contains the data in the repetition database, or the data in the repetition database contains the comparison data.

The first information may include a combination formed by one or more items in the data that requires complete matching and a value of the combination after being processed by a hashing algorithm or an encryption algorithm. The second information includes at least a value of a portion of the data that requires similarity degree matching after being processed by a compression algorithm. The one or more items in the combination may be preset. The first information and the second information are saved in the repetition database by a pair of key and value.

Before the data structure of the comparison data is processed to be the same or substantially the same as the data structure of data in the repetition database, the comparison data may be pre-processed. The pre-processing may include at least one of the following: a upper and lower case conversion, a full and half-width conversion, a special characters filtering, an acrophonetic word replacement, a simple and meaningless word replacement, a keyword extraction, and a removal of HTML tags.

Before the data structure of the comparison data is processed to be the same as the data structure of data in the repetition database, the comparison data needs to be received. The comparison data may be sent through load balance processing.

The present disclosure also provides an apparatus for processing repetitive data. The apparatus includes a processing module, a comparison module, and a writing module. The processing module processes a data structure of comparison data the same or substantially the same as a data structure of data in a repetition database. The repetition database is formed by an internal memory mapping after data in a database is processed according to a preset data structure. The comparison module compares the processed comparison data with the data in the repetition database to determine whether the comparison data is repetitive data. After it is determined that the comparison data is not the repetitive data, the writing module writes the comparison data into the database.

When the processed comparison data includes first information for complete matching and second information for similarity degree matching, the comparison module determines the comparison data to be repetitive data if the first information of the comparison data is the same as the first information of the data in the repetition database and a similarity degree between the second information of the comparison data and the second information of the data in the repetition data is higher than a threshold.

When the processed comparison data also contains one or more images, the comparison module determines whether the comparison data is repetitive data as follows. When the first information of the comparison data is the same or substantially the same as the first information of the data in the repetition database and a similarity degree between the second information of the comparison data and the second information of the data in the repetition data is higher than a threshold, a form of relationship between the comparison data and the repetitive data is determined based on a relationship between sizes of the one or more images in the comparison data and sizes of the one or more images in the data in the repetition database. The form of relationship between the comparison data and the repetitive data may include one of the following: the comparison data is the same as the data in the repetition database, the comparison data contains the data in the repetition database, or the data in the repetition database contains the comparison data.

The first information includes at least a combination formed by one or more items in the data that requires complete matching and a value of the combination after being processed by a hashing algorithm or an encryption algorithm. The second information includes at least a value of a portion of the data that requires similarity degree matching after being processed by a compression algorithm.

The apparatus may further include a pre-processing module to pre-process the comparison data. The pre-processing may include at least one of the following: an upper and lower case conversion, a full and half-width conversion, a special characters filtering, an acrophonetic word replacement, a simple and meaningless word replacement, a keyword extraction, and a removal of HTML tags.

The present disclosure also provides a system of processing repetitive data. The system includes one or more above apparatuses of processing repetitive data and a distribution device. The distribution device, according to the load of the one or more above apparatuses, sends the comparison data to the one or more above apparatuses.

The present disclosure resolves the low efficiency of repetition elimination processing in current technology and the issues arising from simply adding servers, thereby increasing the efficiency of the server in processing repetition eliminations and saving server resources.

### BRIEF DESCRIPTION OF THE DRAWINGS

To better illustrate embodiments of the present disclosure, the following is a brief introduction of figures to be used in descriptions of the embodiments. It is apparent that the following figures only relate to some embodiments of the present disclosure and should not be used to limit the scope of the present disclosure.

FIG. 1 illustrates a flowchart of an example method of data extraction to eliminate repetitive product information under the current technology.

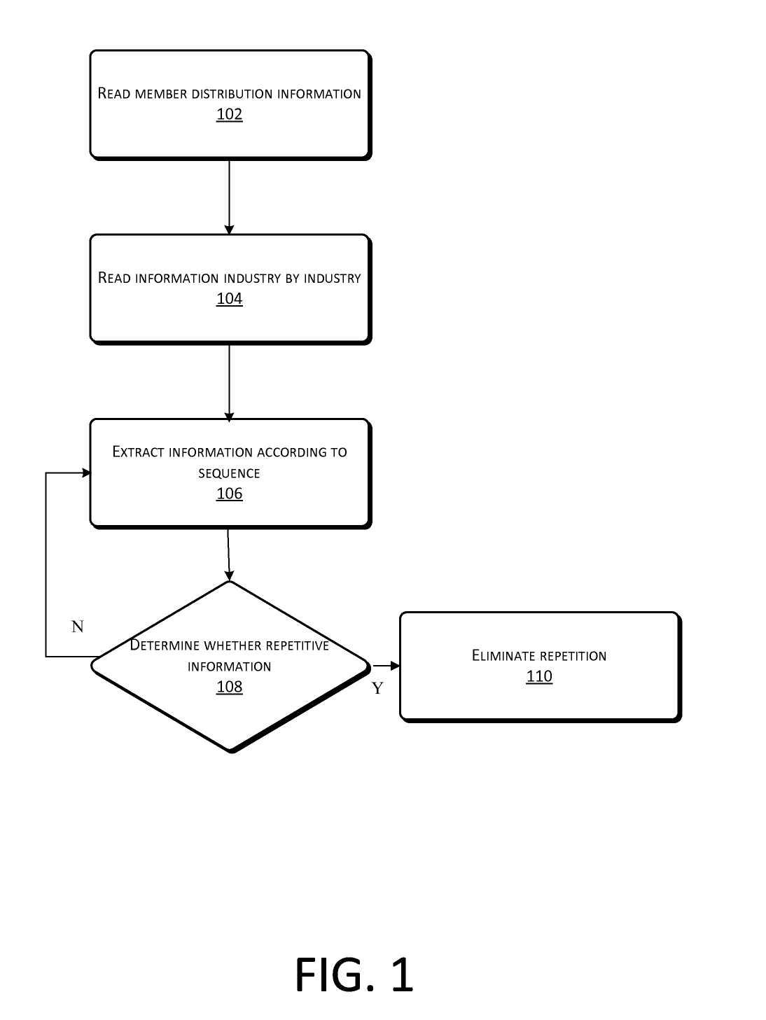

FIG. 2 illustrates a flowchart of an example method of processing repetitive data in accordance with the present disclosure.

FIG. 3 illustrates a diagram of an example apparatus of processing repetitive data according to the present disclosure.

FIG. 4 illustrates a diagram of another example apparatus of processing repetitive data according to the present disclosure.

FIG. 5 illustrates a diagram of an example sub-system of detecting and eliminating repetitive data in accordance with the present disclosure.

FIG. 6 illustrates a flowchart of an example title pre-processing method in accordance with the present disclosure.

FIG. 7 illustrates a flowchart of an example detailed description pre-processing method in accordance with the present disclosure.

FIG. 8 illustrates a flowchart of an example product attribute parameter pre-processing method in accordance with the present disclosure.

FIG. 9 illustrates a diagram of an example repetition database based on distributed buffered and its input and output.

FIG. 10 is a flowchart of an example method for determining repetition in accordance with the present disclosure.

FIG. 11 illustrates a flowchart of an example repetition processing method when data A includes data B according to the present disclosure.

FIG. 12 illustrates a flowchart of an example repetition processing method when data A==data B according to the present disclosure.

### DETAILED DESCRIPTION

The detailed description of the present disclosure is described below with reference to the FIGs. It should be noted that, unless there is a conflict, the example embodiments and the example features of the example embodiments may be mutually used in combination.

The method of processing repetitive data may be applied through a server that is designated for processing repetitive data, a group of servers, or a module coupled with other modules performing other common functionalities within the server.

In an example embodiment, an example database for data comparison uses a form of internal memory database (hereinafter referred to as the repetition database) method. The example embodiments may use, but are not limited to, the internal memory database based on a pair of key and value. The following example embodiments may use the internal memory database based on a pair of key and value for illustration purposes. The current technology uses the method of directly reading and extracting data from the database to carry out item by item comparison to process repetitive data.

The following example embodiments use the internal memory database as the repetition database that allows higher processing efficiency than the current technology. Using the algorithm complexity O(n) as the assessment method for example, as the processing speed of internal database is fast, the value of n does not have much affects on O(n). Thus, compared with the current technology, the following example embodiments improve the internal performance of the server and complete larger data processing while using less resources of the server. In other words, based on the same processing efficiency, the following example embodiments use less resources of the server compared with the current technology. Based on the same resources of the server, the following example embodiments have higher processing efficiencies than the current technology. In addition, as the example embodiments use the internal memory database for processing, expansion under the present disclosure is also relatively easier than expansion under the current technology.

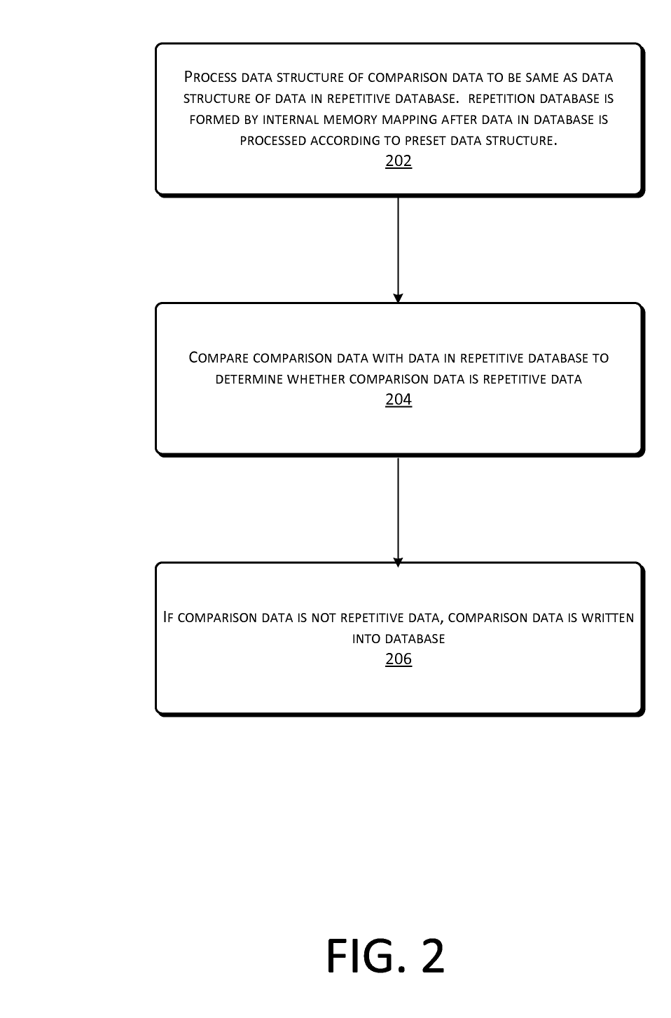

FIG. 2 illustrates a flowchart of an example method of processing repetitive data in accordance with the present disclosure.

At 202, the data structure of the comparison data (i.e., the data to be compared, also called the data to be verified, the data to be checked, or the data to be processed) is processed to be the same or substantially the same as the data structure of data in the repetition database. The repetition database is formed by an internal memory mapping after the data in a database is processed according to a preset data structure. The data structure of the data in the repetition database may be the same as the preset data structure, which may be the same as the data structure in the database. However, this may result in a relatively large amount of data in the repetition database. Alternatively, the data structure of the data in the repetition database may be not the same as the data structure of the data in the database. For example, the data in the repetition database may be an internal memory mapping of the data from the database after the data has been processed, partially compressed, etc. Such processing is equivalent to lots of extraction and concentration tasks, which not only reduces the amount of data in the database but also provides a better data structure for the data comparison.

At 204, the processed comparison data is compared with the data in the repetition database to determine whether it is repetitive data.

At 206, if the comparison data is not repetitive data, the comparison data is written into the database.

The above operations not only avoid item-by-item querying of the database through the internal memory mapping but also eliminate repetition prior to the information being entered in the database so that repetitive data is eliminated from the source.

In an example embodiment, the data structure of the repetition database is internal memory mapping. Furthermore, for the same piece of data, the repetition database is a copy of the data in the database after pre-processing (e.g., the core and required portions to be compared are retained). Thus, a size of the repetition database is much smaller than that of the original database.

Concerning the comparison method used at 204 to determine whether the comparison data is repetitive data, current comparison methods such as a complete comparison method may be used. Even though current comparison methods are used, as the internal memory database is used in the operations, the techniques of the present disclosure may achieve higher efficiency than the current technology.

In another example embodiment, the present disclosure provides a comparison method that combines a complete comparison and a degree of similarity comparison. Such comparison method takes into account of both comparison accuracy and efficiency. The comparison method is described in detail below.

The comparison data may be processed into first information and second information. The first information is used for complete matching and the second information is used for degree of similarity matching. The first information may be compared at first. When the first information of the comparison data completely matches the first information of data in the repetition database, the second information is compared. If the degree of similarity between the second information of the comparison data and the second information of the data in the repetition database exceeds a threshold value, the comparison data is determined to be repetitive data. The first information may be relatively important information whose importance value is higher than a threshold, such as title, keyword, publisher's ID, etc. For this relatively important information, one item or a combination of items in the information may be compared. Thus the extent of the accuracy matching may be flexibly controlled. It is apparent that the more information to compare, the higher the rate of accuracy will be. The second information may be information with relatively larger amounts of data whose data amount is higher than a threshold, such as a product manual, a product description, etc. As the large amount of data is generally not the exactly same but often similar, a similarity degree comparison of the second information may be conducted.

With regard to complete matching comparison, the portion that requires comparison may be compared by using an item by item comparison method. For example, if the title and publisher need to be compared, the title may be compared at first. If the titles are the same, the publisher may be compared for a match. This comparison method is easily realized but its efficiency is rather low. This example embodiment provides another processing method as follows.

With regard to the portion of data that requires complete matching, one or more items in the portion of data are firstly formed into a combination, and then the combination is processed by a hashing or encryption algorithm to obtain a value. This value is then used to carry out comparison. By using this type of method, if there are several portions of the data that need comparing, they can be compared at one time. For example, message digest algorithm5 (MD5) may be used to calculate the combination formed by one or more items in the portion of data requiring complete matching to achieve a 128 bit value. Some other calculation algorithms such as secure hash algorithm (SHA) may be alternatively used. The repetition database may store the portion of data that requires complete matching, a combination of one or more items in the portion of data, or a value of the combination after being processed by hashing or encryption algorithm.

For example, the portion (or text) of the data that requires complete matching is the title and the ID of the publisher. A combination of the title and the ID of the publisher may obtain a string (e.g., “sanfangmobile mobie3”, where sanfangmobile is the product name and mobie3 is the ID of the publisher). The string is then calculated using MD5 to obtain a 128 bit value and the value is used for comparison.

In some large scale databases, there might be relatively more key portions (or texts). For flexibility, the portions that require complete matching may be set within a configuration file. The key portions (or texts) that need complete matching may be obtained each time when the configuration file is read. In other words, the one or more items that form the combination may be preset.

With regard to similarity degree matching, as the portion of data that requires similarity degree matching may be relatively large, the method of extracting keywords may be used. For example, different keywords may be extracted from different positions at different lines. If these keywords are same (or the similarity degree is 100%) or the similarity degree is higher than a threshold, such as 90%, the portion of data is regarded as repetitive data. The method of extracting keywords may be relatively complex.

Alternatively, the present disclosure provides another method that compares the value of the portion of data that requires similarity degree matching and is processed by a compression algorithm. For example, the detailed description in the comparison data is compressed to obtain a value. The detailed description in the repetition database is compressed to obtain another value. The value, for example, may be a size of data after compression. The two values are compared. If the similarity degree between the two values exceeds a threshold value, the comparison data is determined as repetitive data. For example, A is the size of the detailed description in the comparison data after compression and B is the size of the detailed description in the repetition database after compression. The threshold may be, for example, whether (A−B)/A*100% is less than 1%. If the threshold is less than 1%, the portion in the comparison data is determined as repetitive data.

The above complete matching method and similarity degree matching method may be applied individually or in combination. The application of one of these two methods may result in higher accuracy and improved comparison efficiency, and application of the two methods in combination may produce even better results.

The above similarity degree matching method and complete matching method may be applied not only to characters but also to images. For example, the images may be converted into binary data for comparison. When the first information of the comparison data is the same or substantially the same as the first information of the data in the repetition database and a similarity degree between the second information of the comparison data and the second information of the data in the repetition data is higher than a threshold, a form of relationship between the comparison data and the repetitive data is determined based on a relationship between sizes of the one or more images in the comparison data and sizes of the one or more images in the data in the repetition database. The form of relationship between the comparison data and the repetitive data may include one of the following: the comparison data is same as the data in the repetition database, the comparison data contains the data in the repetition database, or the data in the repetition database contains the comparison data.

To make the complete matching and similarity degree matching result more accurate, before the data structure of the comparison data is processed to be the same as the data structure of the data in the repetition database, the comparison data may be pre-processed. The pre-processing may include at least one of the following: an upper and lower case conversion, a full and half-width conversion, a special characters filtering, an acrophonetic word replacement, a nonsense word replacement, a keyword extraction, and a removal of HTML tags. One or more of the above pre-processing operations may be conducted. The more pre-processing operations that are carried out, the easier it is to determine whether the comparison data is repetitive data.

When there is a large amount of data, several servers may be used to process repetitive data. For example, the comparison data may be transmitted by an asynchronous information system with a load balance function. When there are several servers, one server may be selected according to the condition of each server's load or an ID of the comparison data. (Generally each comparison data has a numeric ID. If the comparison data does not have numeric ID, a sequence number may be used to identify the comparison data. For example, the ID or sequence number of the comparison data is 3334, if there are three servers, then the remainder of 3334 after division by 3 is 1. Thus server 1 is used to process the comparison data.)

When there are multiple servers, a distribution database framework based on internal memory database may be used. The example embodiment implements the internal memory database distribution framework by integrating the internal memory database and the distribution database agent. For example, a high-performance internal memory database, such as H2, and a distribution database agent, such as Amoeba, can be integrated. Under the current technology, Amoeba can be integrated with Mysql. With respect to Amoeba, the Mysql node and the H2 node storage have no difference as storage. Thus, the integration of Amoeba and Mysql under the current technology can be transposed to the integration of Amoeba and H2. The integration of Amoeba and H2 can be used to implement the distribution database framework based on the internal memory database.

The present disclosure also provides an apparatus of processing repetitive data. The apparatus of processing repetitive data is used to implement the example methods as described herein. For brevity, the details of those already described are not repeated herein. The term “module” is a combination of software and/or hardware to implement the preset functions. Although the example methods and systems described below may be implemented in the form of software, hardware or a combination of hardware and/or software may also be used for implementation.

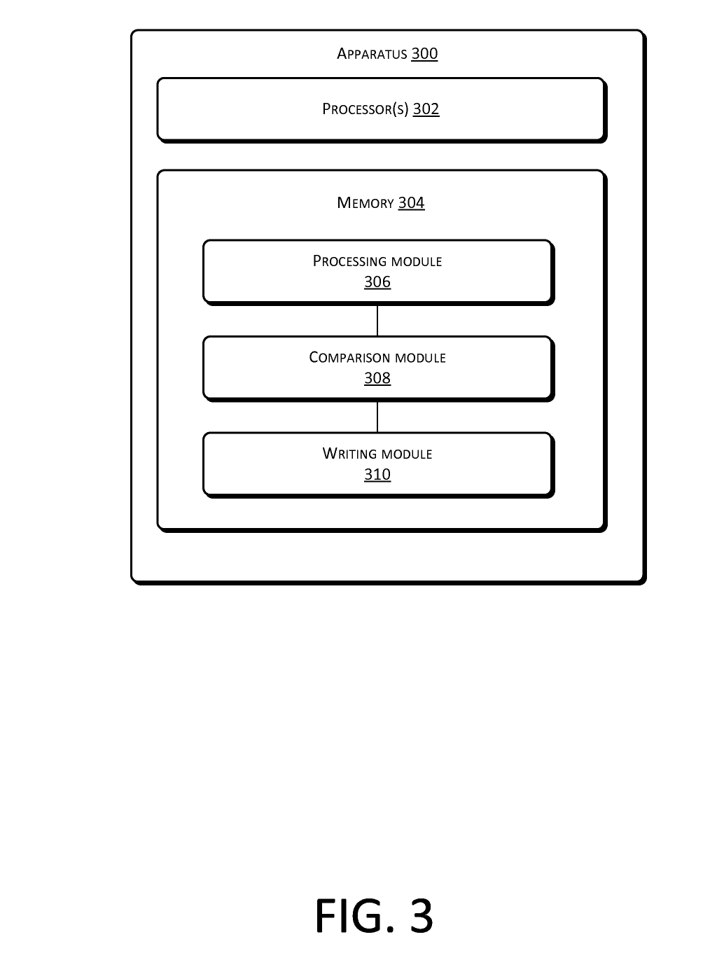

FIG. 3 illustrates a diagram of an example apparatus 300 of processing repetitive data according to the present disclosure. The apparatus 300 may include, but is not limited to, one or more processors 302 and memory 304. The memory 304 may include computer storage media in the form of volatile memory, such as random-access memory (RAM) and/or non-volatile memory, such as read only memory (ROM) or flash RAM. The memory 304 is an example of computer storage media.

Computer storage media includes volatile and non-volatile, removable and non-removable media implemented in any method or technology for storage of information such as computer-executable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer storage media does not include transitory media such as modulated data signals and carrier waves.

The memory 304 may store therein program units or modules and program data. In one embodiment, the modules may include a processing module 306, a comparison module 308, and a writing module 310. These modules may therefore be implemented in software that can be executed by the one or more processors 302. In other implementations, the modules may be implemented in firmware, hardware, software, or a combination thereof.

The processing module 306 processes the data structure of the comparison data to be the same or substantially the same as the data structure of the data in the repetition database. The repetition database is formed by an internal memory mapping after the data in a database is processed according to a preset data structure. The comparison module 308 is connected with the processing module 306 and compares the processed comparison data with the data in the repetition database to determine whether the comparison data is repetitive data. The writing module 310 is connected with the comparison module 308. After it is determined that the comparison data is not the repetitive data, the writing module 310 writes the comparison data into the database.

In one example embodiment, when the processed comparison data includes first information for complete matching and second information for similarity degree matching, the compassion module 308 determines the comparison data as the repetitive data if the first information of the comparison data is the same as the first information of the data in the repetition database and a similarity degree between the second information of the comparison data and the second information of the data in the repetition database is higher than a threshold.

In another example embodiment, when the processed comparison data also contains one or more images, the comparison module 308 determines whether the comparison data is repetitive data as follows. When the first information of the comparison data is the same or substantially the same as the first information of the data in the repetition database and a similarity degree between the second information of the comparison data and the second information of the data in the repetition data is higher than a threshold, the comparison module 308 determines a form of relationship between the comparison data and the repetitive data based on a relationship between sizes of the one or more images in the comparison data and sizes of the one or more images in the data in the repetition database. For example, without limitation, the form of relationship between the comparison data and the repetitive data includes one of the following: the comparison data is same as the data in the repetition database, the comparison data contains the data in the repetition database, or the data in the repetition database contains the comparison data. The form that the comparison data is the repetitive data may also take other representations.

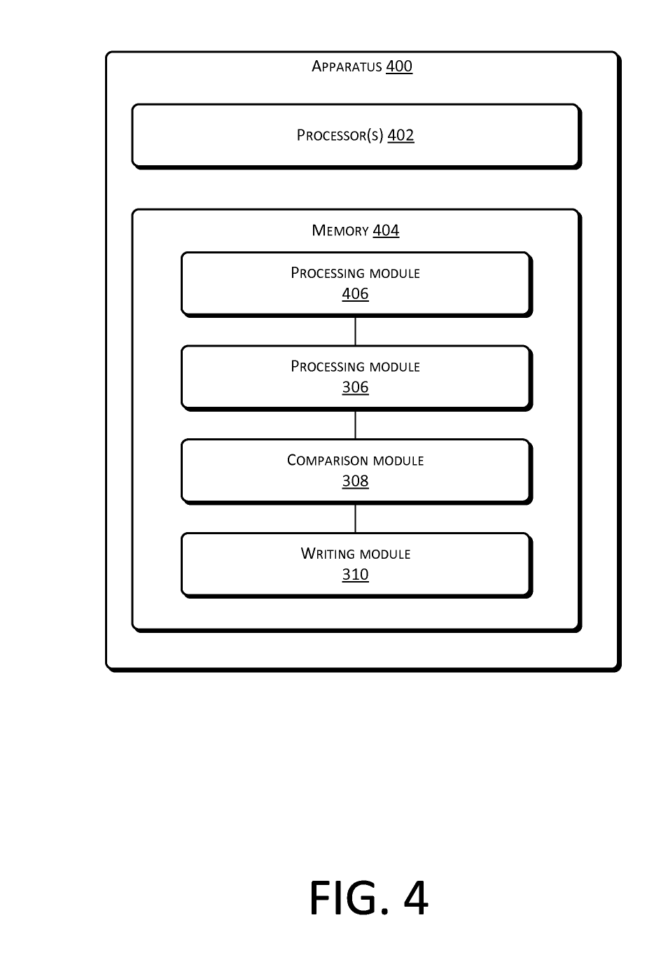

FIG. 4 illustrates a diagram of another example apparatus 400 of processing repetitive data according to the present disclosure. The apparatus 400 may include, but is not limited to, one or more processors 402 and memory 404. The memory 404 may include computer storage media in the form of volatile memory, such as random-access memory (RAM) and/or non-volatile memory, such as read only memory (ROM) or flash RAM. The memory 404 is an example of computer storage media.

The memory 404 may store therein program units or modules and program data. In one embodiment, the modules may include not only the processing module 306, the comparison module 308, and the writing module 310 as shown in FIG. 3, but also a pre-processing module 405. These modules may therefore be implemented in software that can be executed by the one or more processors 402. In other implementations, the modules may be implemented in firmware, hardware, software, or a combination thereof.

The pre-processing module 405 is connected with the processing module 306. The pre-processing module 405 pre-processes the comparison data. The example pre-processing may include at least one of the following: an upper and lower case conversion, a full and half-width conversion, a special characters filtering, an acrophonetic word replacement, a nonsense word replacement, a keyword extraction, and a removal of HTML tags.

The present disclosure also provides a system of processing repetitive data. The system may include one or more above apparatuses of processing repetitive data and a distribution device. The distribution device, according to the load of the one or more above apparatuses, sends the comparison data to the one or more above apparatuses.

In the above example embodiments, an internal memory mapping method (even massive data only requires one-time internal memory mapping) to carry out fast positioning and pre-processing of product information, as well as a comparison method integrated by a complete matching and a similarity degree matching are used. The repetitive data is eliminated from the source, thereby realizing elimination processing before the information is entered into the database, improving efficiency, removing unnecessary disturbance, and increasing matching accuracy. All of these technical results may be achieved in some not all of the example embodiments.

The following is an example embodiment of elimination processing for product information at a large scale e-commerce website. It should be noted that the following example embodiment uses product information as examples. However, the elimination processing for other kinds of information may also use methods in the following example embodiment.

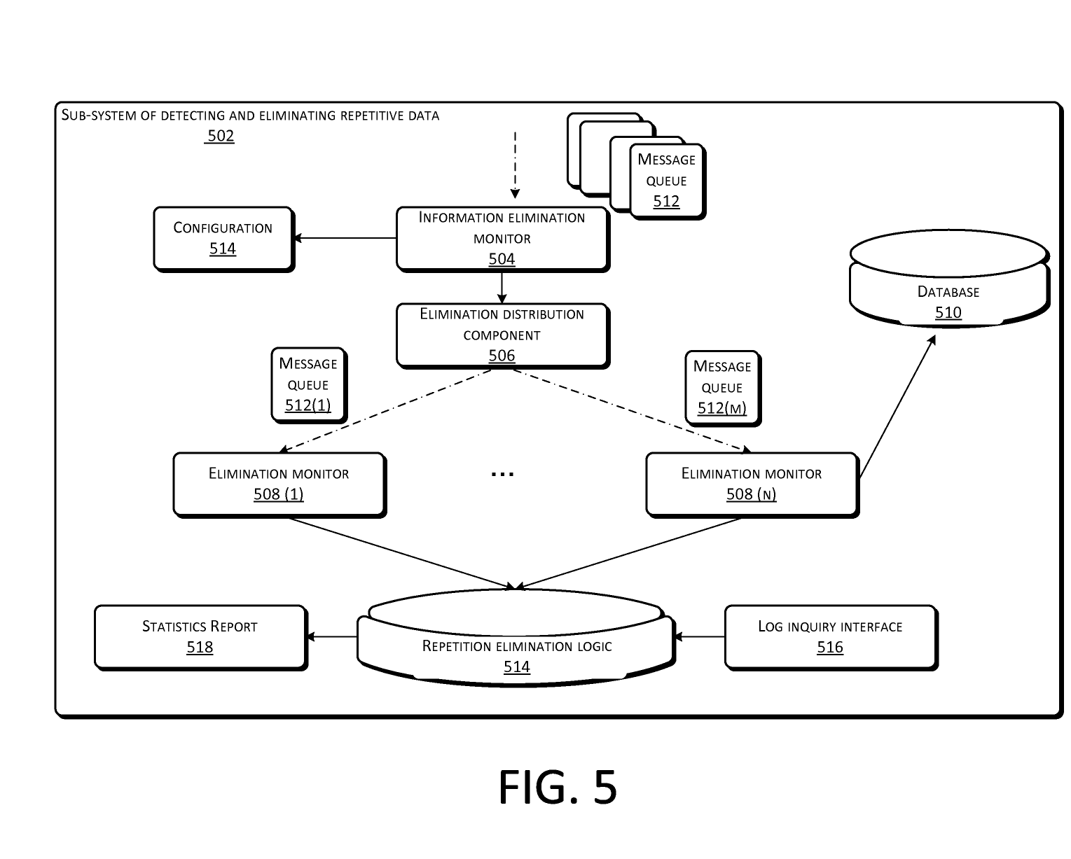

The example embodiment provides a system of fast detecting and eliminating repetitive data. The system of fast detecting and eliminating repetitive data is a sub-system of a back-end verification system. The information to be compared or the comparison data is sent to the present system for processing through a message queue. FIG. 5 illustrates a diagram of an example sub-system 502 of detecting and eliminating repetitive data in accordance with the present disclosure. The sub-system of detecting and eliminating repetitive data 502 includes an information elimination monitor 504, an elimination distribution component 506 (to realize the functions of the above distribution device), one or more elimination monitors 508 (1), . . . , 508(n) (which can also be understood as servers that implement elimination functions), where n may be any integer, and a database 510. The following descriptions are described by reference to FIG. 5 to illustrate the process to clean repetitive data in the product information. The one or more elimination monitors 508 may be one or more servers that perform elimination logics. If the internal memory of the elimination monitors 508 are sufficiently large, the elimination monitors 508 may also serve as the internal memory database.

The back-end information verification monitor performs other processing logics related to verifying the information. Then the verification information is sent to the information elimination monitor 504 through a message queue 510. The elimination distribution component 506 may, based on the ID of the publisher and/or each server's load, send the verification information to different message queues. For example, the first character of the distributor's ID may be used to determine which one of the elimination monitors 508 to send the verification information. The load balancing method may be used to ensure equal processing volumes by each server.

Each message queue such as 512(1), . . . , 512(m), where m may be any integer, is processed by one of the elimination monitors 508(1), . . . , 508(n). For example, the elimination monitor 508(1) may receive message queue 512(1). The elimination monitor 508(n) may receive message queue 512(m).

The information elimination monitor 504, the elimination distribution component 506, and the one or more elimination monitors 508 perform the logics to eliminate repetition. The logics to eliminate repetition include pre-processing, determining repetition, eliminating repetition, and determining whether to update the database depending on the result of the eliminating repetition.

In one example, once the repetition information has been eliminated, a repetition elimination log 514 will be recorded. A log inquiry interface 516 may be provided to inquire the eliminated information. The repetition elimination log 514 may also be mined to have a statistics report 518.

In one example, the above system may be an asynchronous information system. The system, based on the asynchronous and non-block information transmission mechanism, realizes loose coupling with other sub-systems. The loose coupling may support a plug-in method which means that the above elimination system, as a sub-system, may easily connected to other systems. The above asynchronous and non-block information transmission mechanism can improve throughput and processing speed and, together with load balancing, is suitable for large throughput operations. The information elimination monitor 504 may operate based on a configuration file 514.

The following is an illustration an example pre-processing of product information. The pre-processing occurs prior to the comparison of the product information. As an example of pre-processing of texts in the information, at least one of the following modules may be used to implement the pre-processing. Certainly, more or all modules may be used to achieve better results.

A special symbol filtering module that filters special characters from a designated character table (e.g., dashes, I, ←↑, Latin alphabet, etc.).

An acrophonetic word replacement module that replaces characters according to similar shape, pronunciation, or meaning (e.g., “ [symbol] ” and “ [symbol] ” which are both Chinese characters and have same pronunciation “xiang”, “Qian Ke” and “kg,” etc.).

A meaningless word replacement module that replaces simple and meaningless characters (e.g. “of,” etc.).

A core keyword extraction module that, according to a character table, extracts designated characters (also called core keywords) from a text.

For example, the processing methods of the above modules may be based on a dictionary method, In other words, the modules, based on their respective logics, maintain a dictionary file corresponding to processing rules respectively. When the system starts, the corresponding dictionary file is loaded into the internal memory.

The following describes the pre-processing of information by reference to figures and by using the information's parameters such as title, detailed description, and attribute.

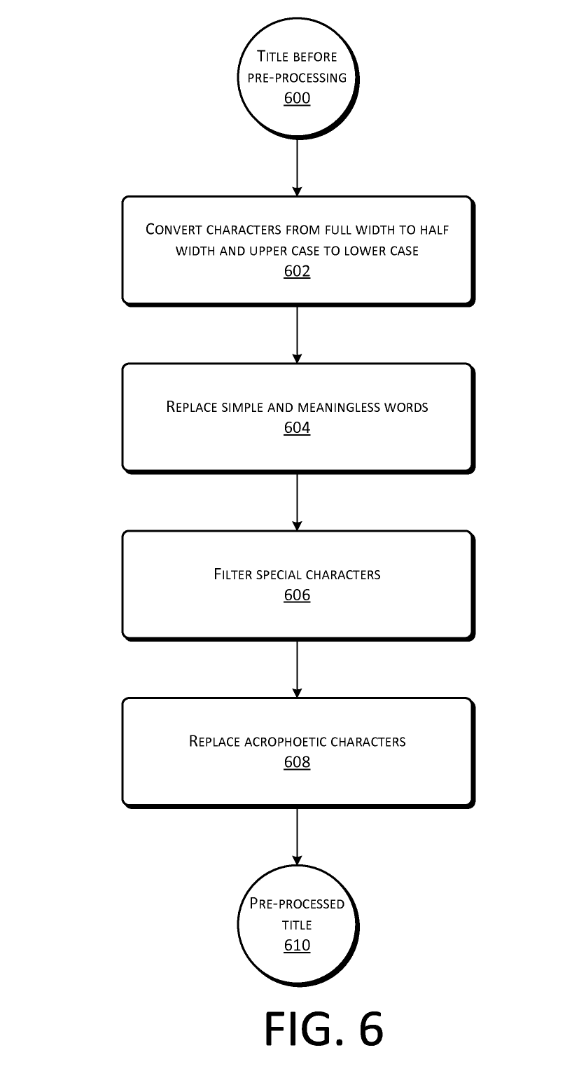

FIG. 6 illustrates a flowchart of an example title pre-processing method in accordance with the present disclosure. A title before pre-processing 600 may undergo one or more of the following operations.

At 602, the characters in the title are converted from full width to half width and upper case to lower case. At 604, the simple and meaningless words in the title are replaced. At 606, the special characters in the title are filtered. At 608, the acrophonetic characters in title are replaced. A pre-processed title 610 is obtained.

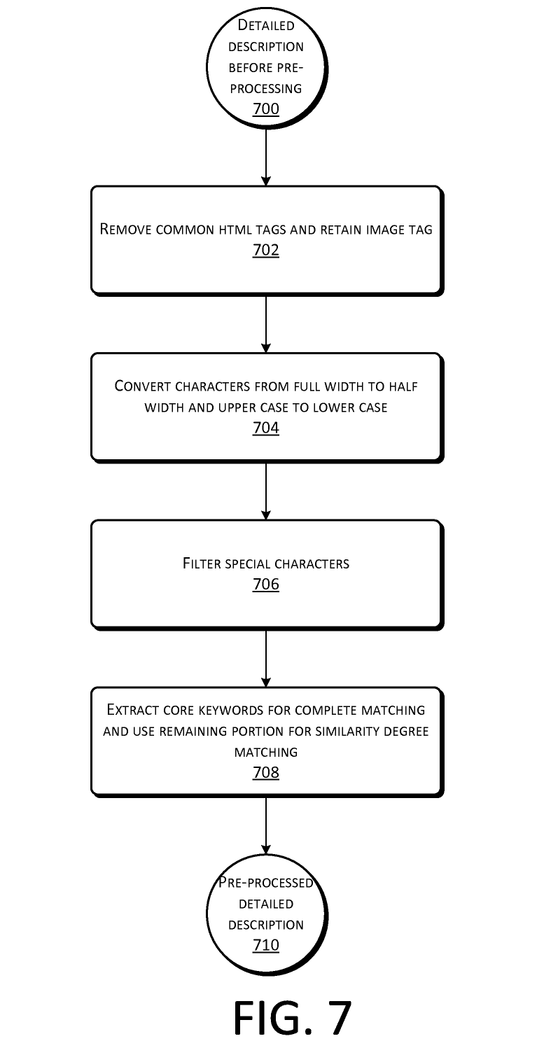

FIG. 7 illustrates a flowchart of an example detailed descriptions pre-processing method in accordance with the present disclosure. A detailed description before pre-processing 700 may undergo one or more of the following operations.

At 702, the common HTML tags are removed. In some example, the image tags are retained. At 704, the characters in the detailed description are converted from full width to half width and upper case to lower case. At 706, the special characters in the detailed description are filtered. At 708, the core keywords are extracted from the detailed description for complete matching and the remaining portions are used for similarity degree matching. A pre-processed detailed description 710 is obtained and is divided into the two portions.

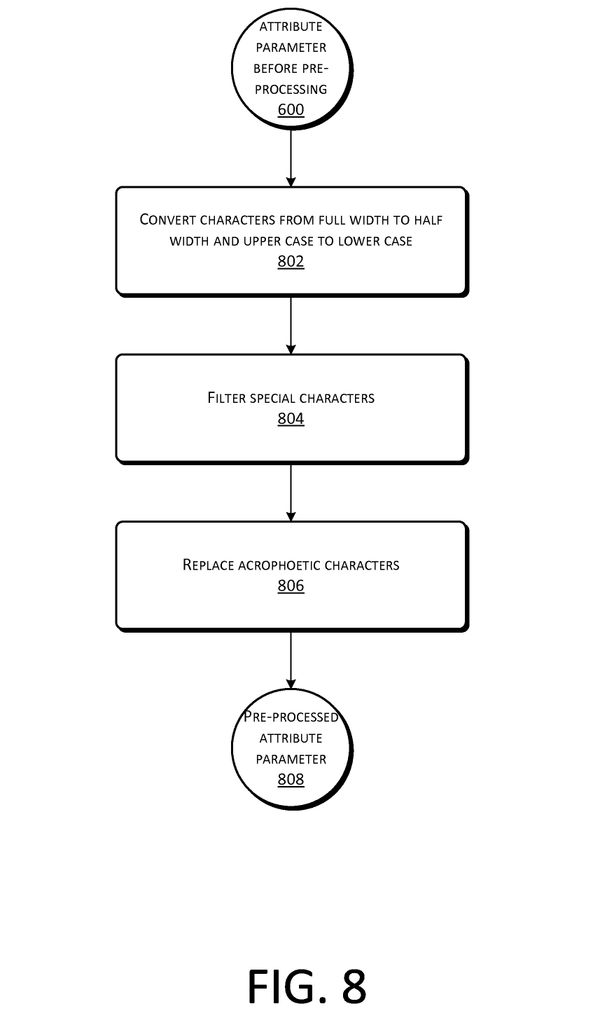

FIG. 8 illustrates a flowchart of an example product's attribute parameter pre-processing method in accordance with the present disclosure. A product's attribute parameter before pre-processing 800 may undergo one or more of the following operations.

At 802, the characters in the attribute are converted from full width to half width and upper case to lower case. At 804, the special characters in the attribute are filtered. At 806, the acrophonetic characters in the attribute are replaced. A pre-processed product's attribute parameter 808 is obtained and is divided into the two portions.

The pre-processing of the key portions of the comparison data, such as the title, the detailed description, the attribute parameters, the image, etc., may eliminate a lot of unnecessary interferences in the product information, thereby greatly increasing the matching accuracy.

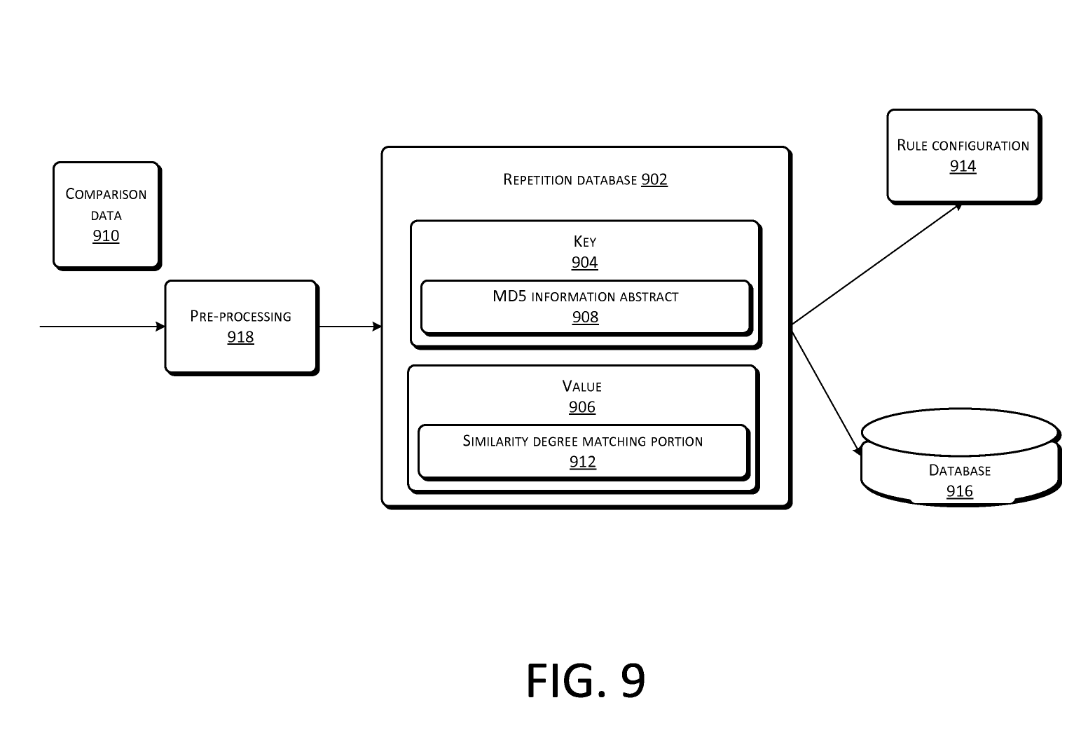

In another example embodiment, the present disclosure also provides a repetition information comparison database based on distributed buffered that uses internal memory mapping method to replace the direct cyclical query comparison by the database. FIG. 9 illustrates a diagram of an example repetition database 902 such as a repetition information comparison database based on distributed buffered and its input and output. The following is a description of processing massive product information by using the repetition database 900 and by reference to FIG. 9.

FIG. 9 illustrates a logic map structure, i.e., a pair of key and value maintained in the internal memory. The structure includes a key 904 and a value 906.

In one example, the key 904 is equivalent to MD5 (information publisher ID+core keyword string+specific attribute+title). The information distributor ID, the core keyword string, the specific attribute and the title are illustrative examples, and some other key strings or combinations of key strings may also be used for the MD5 function. For instance, the key 904 is related to core keywords portion.

The value 906 is equivalent to a list of <information ID, image size list, pre-processed detailed description>. The information ID, the image size list and the pre-processed detailed description are just illustrative examples and not for limitation. For instance, the value 906 is related to the similarity degree matching portion 912.

The key 904 includes a MD information abstract 908 arising from an integration of the portions in a piece of product information that requires complete matching. As the keywords are pre-processed, the structure is capable to easily and promptly realize complete matching. The MD5 string also reduces the consumption of internal memory.

After the key 904 is matched, the value 906 is used for similarity degree matching by using the similarity degree algorithm. If the similarity degree is higher than a threshold, the comparison data is determined as repetition information.

The portions in the comparison data that require complete matching may be determined based on actual situations. For example, in some circumstances, if the titles are the same, the comparison data is determined as repetition information. For another example, in some other circumstances, after the titles are determined to be the same, the ID of the publisher need to be conducted complete matching to determine whether the comparison data is the repetition data. Thus, in practice, there might be an interface available to the user to pre-define the portions that require complete matching. For example, a special rule configuration file 914 may be used to record the portions that require complete matching. Thus different combinations of complete matching may be flexibly determined depending on different needs. In some examples, after the comparison data 910 is determined not the repetition data in the repetition database 902, it may be stored in a database 916. In some examples, the comparison data 910 may undergo pre-processing 918.

The repetition database 902 may also use the algorithm such as the least recently used algorithm (LSU) to control the capacity up limit. For example, if information B has been stored in the repetition database 902 for more than a preset time threshold, such as a month, and has not been matched, the information B is deleted from the repletion database to control the size of the internal memory.

This example embodiment uses the distributed buffered system, the MD5 generation, and a combination of complete matching and similarity degree matching methods to overcome the query and capacity bottlenecks of a single server and to realize accurate quick matching and lineal expanded by consideration of both efficiency and accuracy. The portions requiring complete matching may be self-defined by rules to implement the comparison flexibility and efficiency of the system. Further, to increase the throughput, the above asynchronous information processing mechanism may also be used.

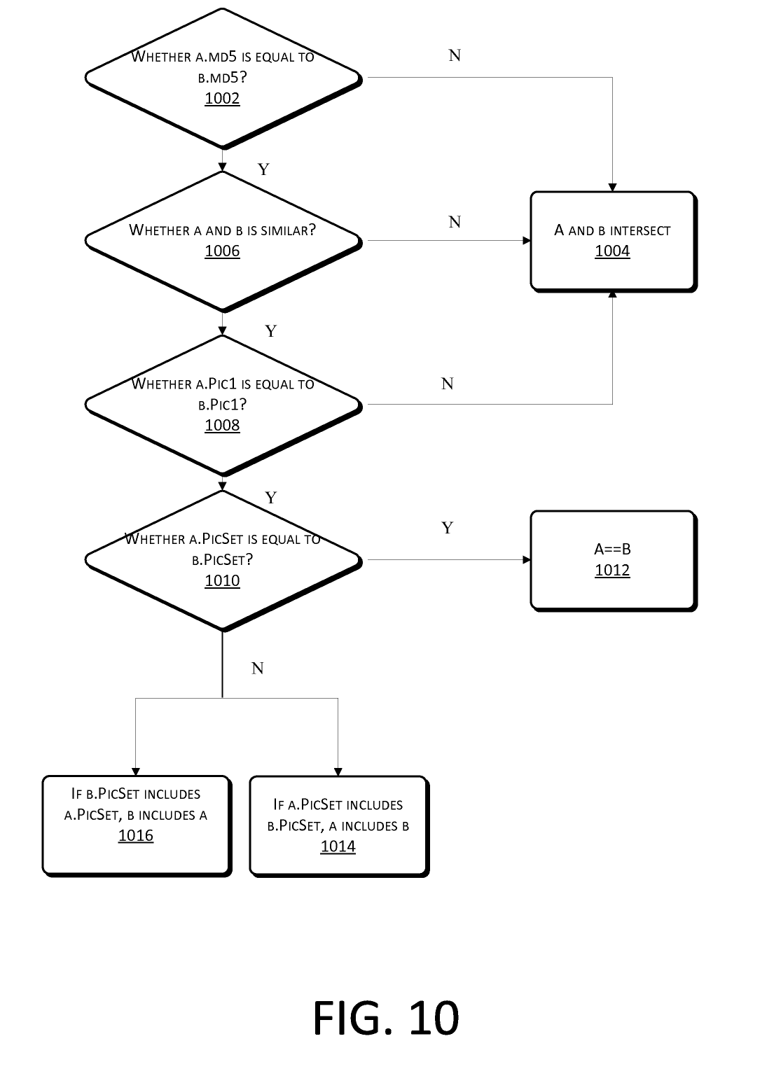

FIG. 10 is a flowchart of an example method for determining repetition in accordance with the present disclosure. The following firstly describes some backgrounds and terminology in FIG. 10 and the following figures.

(1) The comparison information B enters the system, experiences pre-processing, and is then compared with information A in the repetition database.

(2) [M, N] represents the processing results, where M represents that the information is stored in the database and N represents that the information is stored in the repetition database. For example, [A, A] represents that A, after processing, still exists in the database and the repetition database while B is deleted and does not exist anymore in the database or the repetition database.

(3) ˜A represents updating the verification passing time of information A as the system's current time.

(4) A.MD5 represents the MD5 value of A (e.g., publisher ID+core keyword string+specific attribute+title).

(5) A.Pic1 represents the size of the first image in information A. A.PicSet represents the set of sizes of all images in information A excluding the first image.

(6) Similar (A, B) represents a function to determine whether A and B are similar. One example function is represented by zip (A+B)/zip (A)+zip (A+B)/zip(B)<a threshold such as 2.1, where zip (A) represents the size of the detailed description in A after the zip compression. Zip is just one example of compression algorithms. Some other compression algorithms may also be used.

(7) That A and B intersect represents that A and B are not repetitive similar information. A==B represents that A and B are repetitive similar information. A includes B represents that A includes the content of B. B includes A represents that B includes the content of A.

(8) NEW/MOD represents a status of the information: new information pending verification/modified information pending verification. APP/PUB represents another status of the information: information approved by the back-end verification system/information already published at the network. TBD/DEL/EXP represents another status of the information: information not approved by the back-end verification system/information deleted by the back-end verification system/expired online information.

FIG. 10 shows the following operations. At 1002, A.MD5 is determined whether the same as B.MD5. If the result is positive, A and B intersect at 1004. Otherwise, operations at 1006 are performed.

At 1006, A is determined whether similar as B, such as whether zip (A+B)/zip (A)+zip (A+B)/zip(B)<a threshold (e.g., 2.1). If A and B is not similar, A and B intersect. Otherwise, operations at 1008 are performed.

At 1008, it is determined whether the size of A's first image equals the size of B's first image. If they are not equal, i.e., A.Pic1!=B.Pic1, A and B intersect. Otherwise, operations at 1010 are performed.

At 1010, it determines whether the set of sizes of A's all images excluding the first image equals the set of sizes of B's all images excluding the first image. If they are the same, i.e., A.PicSet.equals (B.PicSet), A==B at 1012. If the set of sizes of A's all images excluding the first image includes the set of sizes of B's all images excluding the first image, i.e., A.PicSet.contains (B.PicSet), A includes B at 1014. If the set of sizes of B's all images excluding the first image includes the set of sizes of A's all images excluding the first image, i.e., B.PicSet.contains (A.PicSet), B includes A at 1016.

The operations to control the size of the repetition database may be added into the process. For example, it may determine whether the difference between the timestamp of B and the current time is longer than a threshold. If the result is positive, B is searched through the repetition database according to the information ID of B and is deleted from the repetition database. The performing time of this operation may be not limited. For example, the operation may be performed when the server's load is lower than a threshold.

The above repetition processing may be represented by the following pseudo codes.

a) IF A.MD5!=B.MD5=>A and B intersect

b) ELSEIF !Similar(A, B)=>A and B intersect

c) ELSEIF A.Pic1!=B.Pic1=>A and B intersect

d) ELSEIF A.PicSet.equals(B.PicSet)=>

e) ELSEIF A.PicSet.contains(B.PicSet)=>A includes B

f) ELSEIF B.PicSet.contains(A.PicSet)=>B includes A

g) ELSE A and B intersect

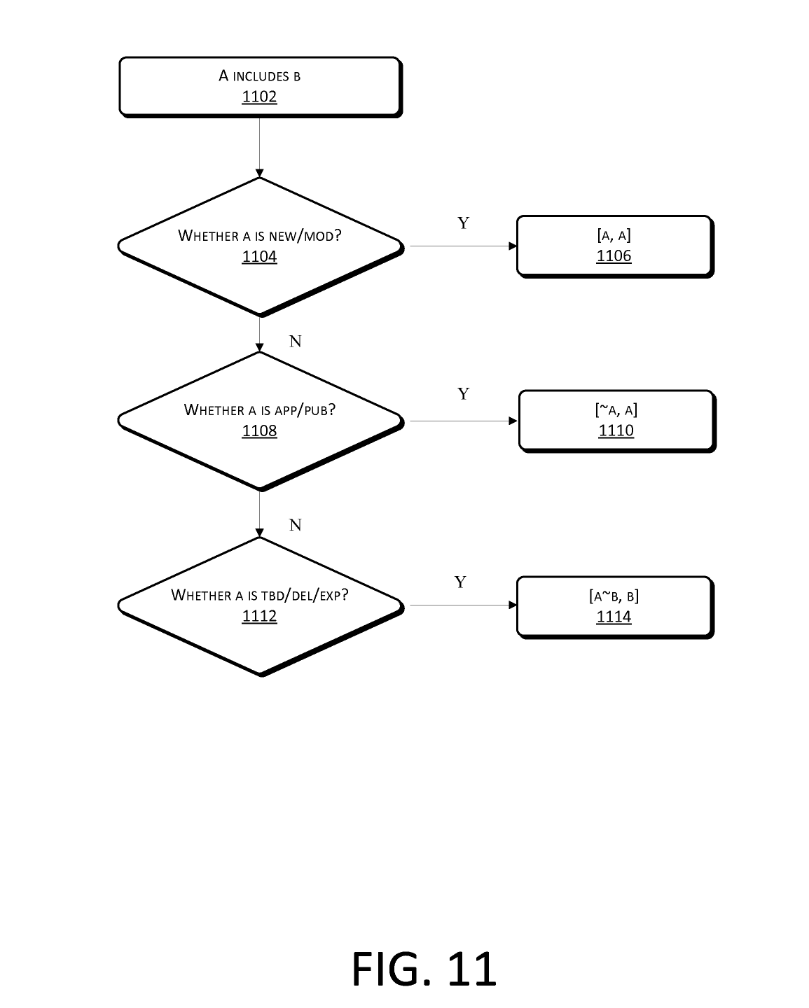

FIG. 11 illustrates a flowchart of an example repetition processing method when A includes B according to the present disclosure. At 1102, A includes B. At 1104, A is determined whether NEW/MOD. If the result is positive, then it's [A, A] at 1106 which represents that A is retained in both the database and the repetition database. Otherwise, operations at 1104 are performed.

At 1108, A is determined whether APP/PUB. If the result is positive, then it's [˜A, A] at 1110 which represents that the verification passing time of A is updated to the current system time in the database, and that A is retained in the repetition database. Otherwise, operations at 1106 are performed.

At 1112, A is determined whether TBD/DEL/EXP. If the result is positive, then it's [A˜B, B] at 1114 which represents that A is retained in the database, that the verification passing time of B is updated to the current system time in the database, and that B is retained in the repetition database.

The above operations may not be necessarily performed according to the sequence from 1102 to 1106. The operations may be performed according to other sequences to achieve a same result. The sequence from 1102 to 1106 is just for illustration.

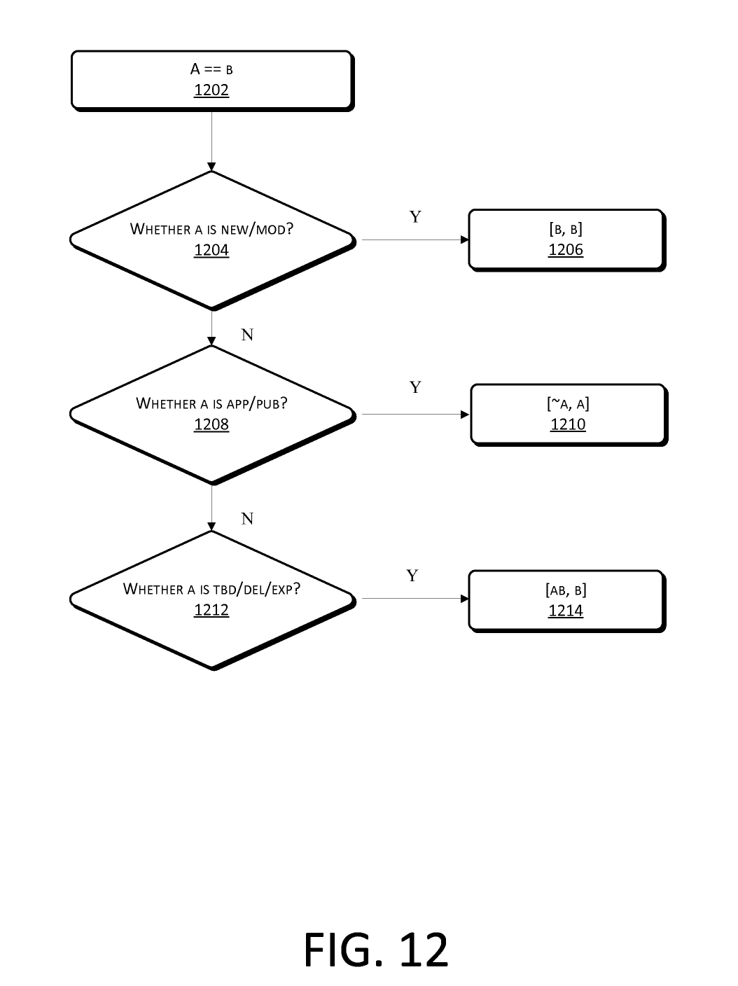

FIG. 12 illustrates a flowchart of an example repetition processing method when A==B according to the present disclosure. FIG. 12 illustrates operations following those in FIG. 10. At 1202, A==B

At 1204, A is determined whether NEW/MOD. If the result is positive, then it's [B, B] at 1206. Otherwise, operations at 1204 are performed.

At 1208, A is determined whether APP/PUB. If the result is positive, then it's [˜A, A] at 1210. Otherwise, operations at 1206 are performed.

At 1212, A is determined whether TBD/DEL/EXP. If the result is positive, then it's [AB, B] at 1214 which represents that A and B are retained in the database and B is also retained in the repetition database

The above operations may not be necessarily performed according to the sequence from 1202 to 1206. The operations may be performed according to other sequences to achieve a same result. The sequence from 1202 to 1206 is just for illustration.

Except for the situations when A includes B and A==B as shown in FIGS. 10 and 11, it is determined that A and B intersect. The above repetition processing may be represented by the following pseudo codes.

| a) IF A includes B | |
|---|---|
| i. | IF A is NEW/MOD => [A , A] |
| ii. | ELSEIF A is APP/PUB => [~A, A] |
| iii. | ELSE A is TBD/DEL/EXP => [A~B, B] |
| b) ELSEIF A == B | |
| i. | IF A is NEW/MOD => [B, B] |
| ii. | ELSE IF A is APP/PUB => [~A, A] |
| iii. | ELSE A is TBD/DEL/EXP => [AB, B] |

c) ELSE A and B intersect => [AB, AB]

In another embodiment, the present disclosure also provides a repetitive data processing software to implement the techniques described in the above example embodiments.

In another embodiment, the present disclosure also provides a computer storage media. The computer storage media stores the above repetitive data processing software, and may be, but not limited to, in the form of DVD, CD-ROM, hard drive, writable storage device etc.

Persons skilled in the art should understand that the embodiments of the present disclosure can be methods, systems, or the programming products of computers. Therefore, the present disclosure can be implemented by hardware, software, or in combination of both. In addition, the present disclosure can be in a form of one or more computer programs containing the computer-executable codes which can be implemented in the computer-executable storage medium (including but not limited to disks, CD-ROM, optical disks, etc.).

Persons skilled in the art should understand that the modules or operations described herein may be performed by general-purpose computing devices in single computing device or distributed among multiple computing devices at the network. Optionally, they may be at the computer storage media to be processed by one or more processors or be manufactured into different circuit modules. Alternatively, none or more modules or operations may be integrated into one circuit module. The present disclosure does not limit any specific combination of hardware and/or software.

The present disclosure is described by referring to the flowcharts and/or block diagrams of the method, device (system) and computer program of the embodiments of the present disclosure. It should be understood that each flow and/or block and the combination of the flow and/or block of the flowchart and/or block diagram can be implemented by computer program instructions. These computer program instructions can be provided to the general computers, specific computers, embedded processor or other programmable data processors to generate a machine, so that a device of implementing one or more flows of the flow chart and/or one or more blocks of the block diagram can be generated through the instructions operated by a computer or other programmable data processors.

These computer program instructions can also be loaded in a computer or other programmable data processors, so that the computer or other programmable data processors can operate a series of operation steps to generate the process implemented by a computer. Accordingly, the instructions operated in the computer or other programmable data processors can provides the steps for implementing the functions specified in one or more flows of the flow chart and/or one or more blocks of the block diagram.

The embodiments are merely for illustrating the present disclosure and are not intended to limit the scope of the present disclosure. It should be understood for persons in the technical field that certain modifications and improvements can be made and should be considered under the protection of the present disclosure without departing from the principles of the present disclosure.

1. A method performed by one or more processors configured with computer-executable instructions, the method comprising:
processing a data structure of comparison data to be same or substantially same as a data structure of data in a repetition database, the repetition database being formed by an internal memory mapping after data in a database is processed according to a preset data structure;
comparing the comparison data with the data in the repetition database to determine whether the comparison data is repetitive data; and
in response to a result that the comparison data is not repetitive data, storing the comparison data in the database.

2. The method as recited in claim 1, wherein the processed comparison data includes first information for complete matching and second information for similarity degree matching.

3. The method as recited in claim 2, wherein the comparing the comparison data with the data in the repetition database to determine whether the comparison data is repetitive data comprises:
if the first information of the comparison data is same or substantially same as first information of the data in the repetition database and a similarity degree between the second information of the comparison data and second information of the data in the repetition data is higher than a threshold, determining that the comparison data is repetition data.

4. The method as recited in claim 2, wherein the comparing the comparison data with the data in the repetition database to determine whether the comparison data is repetitive data comprises:
if the first information of the comparison data is same or substantially same as first information of the data in the repetition database and a similarity degree between the second information of the comparison data and second information of the data in the repetition data is higher than a threshold, determining a form of relationship between the comparison data and the data in the repetition database according to a relationship between sizes of one or more images in the comparison data and sizes of one or more images in the data in the repetition database.

5. The method as recited in claim 1, wherein the form of relationship between the comparison data and the data in the repetition database includes one of the following:
the comparison data is same as the data in the repetition database;
the comparison data contains the data in the repetition database;
the data in the repetition database contains the comparison data.

6. The method as recited in claim 2, wherein:
the first information includes at least a combination formed by one or more items in the comparison data that requires complete matching and a value of the combination after the combination is processed by a hashing algorithm or an encryption algorithm; and
the second information includes at least a value of a portion in the comparison data that requires similarity degree matching after the portion is processed by a compression algorithm.

7. The method as recited in claim 6, wherein the one or more items that form the combination are preset.

8. The method as recited in claim 2, wherein the data in the repetition database includes first information for complete matching and second information for similarity degree matching and the first information and the second information are stored in the repetition database in a form of key-value pair.

9. The method as recited in claim 1, further comprising, prior to comparing the comparison data with the data in the repetition database to determine whether the comparison data is repetitive data, pre-processing the comparison data.

10. The method as recited in claim 9, wherein the pre-processing includes at least one of the following:
an upper and lower case conversion;
a full and half-width conversion;
a special characters filtering;
an acrophonetic word replacement;
a simple and meaningless word replacement;
a keyword extraction;
a removal of HTML tags.

11. The method as recited in claim 1, further comprising, prior to comparing the comparison data with the data in the repetition database to determine whether the comparison data is repetitive data, receiving the comparison data through a processing of load-balancing.

12. An apparatus comprising:
a processing module that processes a data structure of comparison data to be same or substantially same as a data structure of data in a repetition database, the repetition database being formed by an internal memory mapping after data in a database is processed according to a preset data structure;
a comparison module that compares the comparison data with the data in the repetition database to determine whether the comparison data is repetitive data; and
a writing module that, in response to a result that the comparison data is not repetitive data, stores the comparison data in the database.

13. The apparatus as recited in claim 12, wherein the processed comparison data includes first information for complete matching and second information for similarity degree matching and the comparison module, after determining that the first information of the comparison data is same or substantially same as first information of the data in the repetition database and a similarity degree between the second information of the comparison data and second information of the data in the repetition data is higher than a threshold, determines that the comparison data is repetition data.

14. The apparatus as recited in claim 13, wherein the comparison data includes one or more images and the comparison module, after determining that the first information of the comparison data is same or substantially same as first information of the data in the repetition database and the similarity degree between the second information of the comparison data and second information of the data in the repetition data is higher than the threshold, determines a form of relationship between the comparison data and the data in the repetition database according to a relationship between sizes of one or more images in the comparison data and sizes of one or more images in the data in the repetition database, the form of relationship between the comparison data and the data in the repetition database including one of the following:
the comparison data is same as the data in the repetition database;
the comparison data contains the data in the repetition database;
the data in the repetition database contains the comparison data.

15. The apparatus as recited in claim 13, wherein:
the first information includes at least a combination formed by one or more items in the comparison data that requires complete matching and a value of the combination after the combination is processed by a hashing algorithm or an encryption algorithm; and
the second information includes at least a value of a portion in the comparison data that requires similarity degree matching after the portion is processed by a compression algorithm.

16. The apparatus as recited in claim 13, wherein the data in the repetition database includes first information for complete matching and second information for similarity degree matching and the first information and the second information are stored in the repetition database in a form of key-value pair.

17. The apparatus as recited in claim 12, further comprising prior to comparing the comparison data with the data in the repetition database to determine whether the comparison data is repetitive data, pre-processing the comparison data, the pre-processing including at least one of the following:
an upper and lower case conversion;
a full and half-width conversion;
a special characters filtering;
an acrophonetic word replacement;
a simple and meaningless word replacement;
a keyword extraction;
a removal of HTML tags.

18. The apparatus as recited in claim 12, further comprising, prior to comparing the comparison data with the data in the repetition database to determine whether the comparison data is repetitive data, receiving the comparison data through a processing of load-balancing.

19. A system comprising:
a distribution device that sends comparison data to one or more apparatuses for processing repetitive data based on load-balance of the one or more apparatuses for processing repetitive data; and
at least one of the one or more apparatuses for processing repetitive data including:
a processing module that processes a data structure of comparison data to be same or substantially same as a data structure of data in a repetition database, the repetition database being formed by an internal memory mapping after data in a database is processed according to a preset data structure;
a comparison module that compares the comparison data with the data in the repetition database to determine that the comparison data is repetitive data after determining that first information of the comparison data is same or substantially same as first information of the data in the repetition database and a similarity degree between second information of the comparison data and second information of the data in the repetition data is higher than a threshold, the first information including at least a combination formed by one or more items in the comparison data that requires complete matching and a value of the combination after the combination is processed by a hashing algorithm or an encryption algorithm, the second information including at least a value of a portion in the comparison data that requires similarity degree matching after the portion is processed by a compression algorithm; and
a writing module that, in response to a result that the comparison data is not repetitive data, stores the comparison data in the database.

20. The system as recited in claim 19, wherein the comparison data includes one or more images and the comparison module, after determining that the first information of the comparison data is same or substantially same as first information of the data in the repetition database and the similarity degree between the second information of the comparison data and second information of the data in the repetition data is higher than the threshold, determines a form of relationship between the comparison data and the data in the repetition database according to a relationship between sizes of one or more images in the comparison data and sizes of one or more images in the data in the repetition database, the form of relationship between the comparison data and the data in the repetition database including one of the following:
the comparison data is same as the data in the repetition database;
the comparison data contains the data in the repetition database;
the data in the repetition database contains the comparison data.
